(19) United States
(12) Patent Application Publication
(10) Pub. No.: US 2016/0086169 A1
(43) Pub. Date: Mar. 24, 2016

(54) AUTOMATED CUSTOMER ASSISTANCE PROCESS FOR TOKENIZED PAYMENT SERVICES

(71) Applicant: CafeX Communications, Ltd., Cardiff (GB)

(72) Inventors: David Jodoin, Boston, MA (US); Rami Musallam, Summit, NJ (US)

(21) Appl. No.: 14/860,115

(22) Filed: Sep. 21, 2015

Related U.S. Application Data
(60) Provisional application No. 62/053,493, filed on Sep. 22, 2014.

(51) Int. Cl. G06Q 20/36; G06Q 20/40

(52) U.S. Cl. CPC G06Q 20/3672; G06Q 20/401; G06Q 2220/00

(57) ABSTRACT

A method (200) for performing a purchase transaction. The method comprises: receiving, by a first computing device operated by a first person, a first transaction token generated by a Tokenization Service Provider (“TSP”) server operated by a TSP; and using the first transaction token to complete a first purchase transaction. When payment is declined during the first purchase transaction, contact details are automatically provided for a card issuer to the first computing device so that a communication session between the first person and a card issuer can be initialized without requiring the first person to search for the contact details. Additionally, the first transaction token is used to retrieve and provide the card issuer with at least one of transaction-specific context information pertaining to the first transaction and account information associated with the first person.

### CROSS-REFERENCE TO RELATED APPLICATION

This application claims priority from U.S. Provisional Application No. 62/063,493 filed on Sep. 22, 2014, which is herein incorporated in its entirety.

### BACKGROUND OF THE INVENTION

1. Statement of the Technical Field

The disclosure relates to tokenized payment services, and more particularly to methods and systems for improved customer services during tokenized payment transactions.

2. Description of the Related Art

Conventional credit card transactions involve several steps. The process begins with a cardholder presenting his card to a merchant to make a payment for a purchase. The merchant then uses the information contained on the card to request an authorization for the transaction. Authorization can be provided directly by a merchant bank (if the merchant has obtained a merchant account) or through third party facilitators (which are sometimes referred to as “payment gateways”). For convenience, the entity receiving the request from the merchant is referred to herein as the acquirer. When the acquirer receives an authorization request from a merchant, it will submit the request to the Credit Card Payment Network (“Payment Network”), which will in turn submit the request to the card issuer. The card issuer will determine if the transaction is authorized. Thereafter, the card issuer will use the Payment Network to send its response to the acquirer concerning the authorization request. The acquirer will then forward the response to the merchant to indicate whether or not the card has been authorized.

Commercially available computing devices allow consumers to facilitate secure payment transactions either online or at a merchant location. Computing devices used for payment transactions online commonly include desktop computers, laptop computers, tablet computers and a wide variety of mobile computing devices which are conventionally known as smart-phones. Secure payment transactions online are commonly referred to as card not present transactions. Conversely, secure payment transactions at a merchant location that use a consumer's portable computing device (e.g., a smart phone) are commonly referred to as card present transactions. In such card present transactions, the portable computing device being used acts in proxy of a physical credit card, debit card or rewards card.

In a scenario where the smart phones or other portable computing device is used to in place of a physical credit card, the device is sometimes referred to as a mobile wallet. In a mobile wallet scenario, computer software is typically loaded onto the portable computing device to link it to a particular credit or debit card account. When the user wishes to complete a purchase transaction, the portable computing device is used to provide the necessary credit card data by means of a scanning or short range wireless data transmission operation.

### SUMMARY OF THE INVENTION

The present disclosure concerns a method for generating and provisioning a token. The method comprises: assigning a first token requester identifier to a first person which allows a Tokenization Service Provider (“TSP”) to unique identify the first person; and receiving, at a TSP server operated by the TSP, a request for a first transaction token from a first computing device operated by the first person and remotely located from the TSP server. The request comprises the first token requester identifier. The TSP server then performs operations to: verify that the request is authentic; generate a first transaction token that is to be used for at least a first transaction upon verification that the request is authentic; and communicate the first transaction token and/or the first token requester identifier to the first computing device so that the first transaction token can be used to complete the first transaction.

When payment is declined during the first transaction, various operations are performed. For example, contact details for a card issuer are automatically provides to the first computing device so that a communication session between the first person and a card issuer can be initialized without requiring the first person to search for the contact details. Additionally, the first transaction token is used to retrieve and provide the card issuer with at least one of transaction-specific context information pertaining to the first transaction and account information associated with the first person after initialization of the communication session, after initialization of the communication session.

In some scenarios, a second computing device operated by a merchant receives at least one of the first token requester identifier and the first transaction token which was communicated from the first computing device. At least one of the first token requester identifier and the first transaction token is communicated from the second computing device to an acquirer server in the form of an authorization request. The acquirer server performs operations to submit the authorization request to a Payment Network (“PN”) server. At least one of the first token requester identifier and the first transaction token is communicated from the PN sever to the TSP sever. Operations are performed by the TSP server to determine a Primary Account Number (“PAN”) associated with at least one of the first token requester identifier and the first transaction token. The PAN is communicated from the TSP server to the PN server. The PN server performs operations to: submit an authorization request including the PAN to a Processing Center (“PC”) server; and accept or decline payment using the PAN.

If payment is accepted, then an authorization response is communicated from the PC server to the PN server indicating that the payment was authorized using the PAN. The PAN is used at the PN server to associate the authorization response to the first transaction token. The first transaction token and the authorization response without the PAN is communicated from the PN server to the acquirer server. The authorization response is forwarded from the acquirer server to a second computing device operated by a merchant to indicate that the purchase transaction was authorized. The second computing device uses the first transaction token to complete the purchase transaction.

If payment is declined, then a decline response is communicated from the PC server to the PN server. The decline response comprises at least one of (1) first information indicating that payment was declined using the PAN and (2) second information specifying a transaction-specific communications link for enabling the first computing device's access to an agent. The PN server uses the PAN to associate the decline response to the first transaction token. The decline response and the transaction token is communicated from the PN server to the TSP server. At least one of the transaction token, information indicating that payment has been declined, and information specifying contact details for a card issuer is communicated from the TSP server to a second computing device operated by a merchant.

In some scenarios, information specifying contact details for the card issuer is communicated to the first computing device when payment is declined. The contact details are used by the first computing device to initiate the communication session with the card issuer. A card issuer server obtains the first transaction token from the first computing device before, during or after initiation of the communication session. The card issuer server used the first transaction token to obtain at least one of transaction-specific context information pertaining to the first transaction and account information associated with the first person.

### BRIEF DESCRIPTION OF THE DRAWINGS

Embodiments will be described with reference to the following drawing figures, in which like numerals represent like items throughout the figures, and in which:

FIG. 1 is a drawing showing a computer system architecture which is useful for understanding how enhanced customer support can be facilitated in a tokenized payment system according to the inventive arrangements.

FIGS. 2A-2D collectively provide a flowchart that is useful for understanding how enhanced customer support can be facilitated in a tokenized payment process.

FIG. 3 is an exemplary computing system which is useful for understanding the inventive arrangements.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As a means of fraud prevention and consumer identity theft prevention, a range of mechanisms have been developed for use with credit cards, debit cards and rewards cards. One such mechanism is known as tokenization, which provides a method of protecting the Primary Account Number (“PAN”) and other information associated with a card. Tokenization transaction methods are commercially available through various Tokenization Service Providers (“TSPs”).

In a system utilizing tokenization, the risk of exposure of consumer card data is greatly reduced. In these types of systems, card data is conventionally replaced at the point of capture with a unique numeric or alpha-numeric sequence that is generated using an encryption method. Once generated, the token (sometimes referred to herein as a “transaction token”) functions as a substitute in place of the actual PAN. The encryption can be reversed to facilitate access to the true PAN value by using the correct decryption keys. The TSP responsible for generating the transaction token will keep track of all issued transaction tokens so that refunds and exchanges can be affected.

In accordance with an exemplary tokenization scheme, a customer's computing device will use software provided by a TSP to obtain a transaction token. TSPs are responsible for building and managing their own proprietary Token Requestor APIs, Token Vaults, Token provisioning platforms, and Token registries. Accordingly, different TSPs will generate and issue tokens using different methods and techniques. In general, however, TSPs will provide the capability for generation and issuance of tokens, and will maintain a mapping as between transaction tokens and PAN values. It should be understood that the inventive arrangements described herein are not limited to any particular process for generating transaction tokens. Instead, the token generation process described herein is intended as merely one possible example of a token generation and provisioning process.

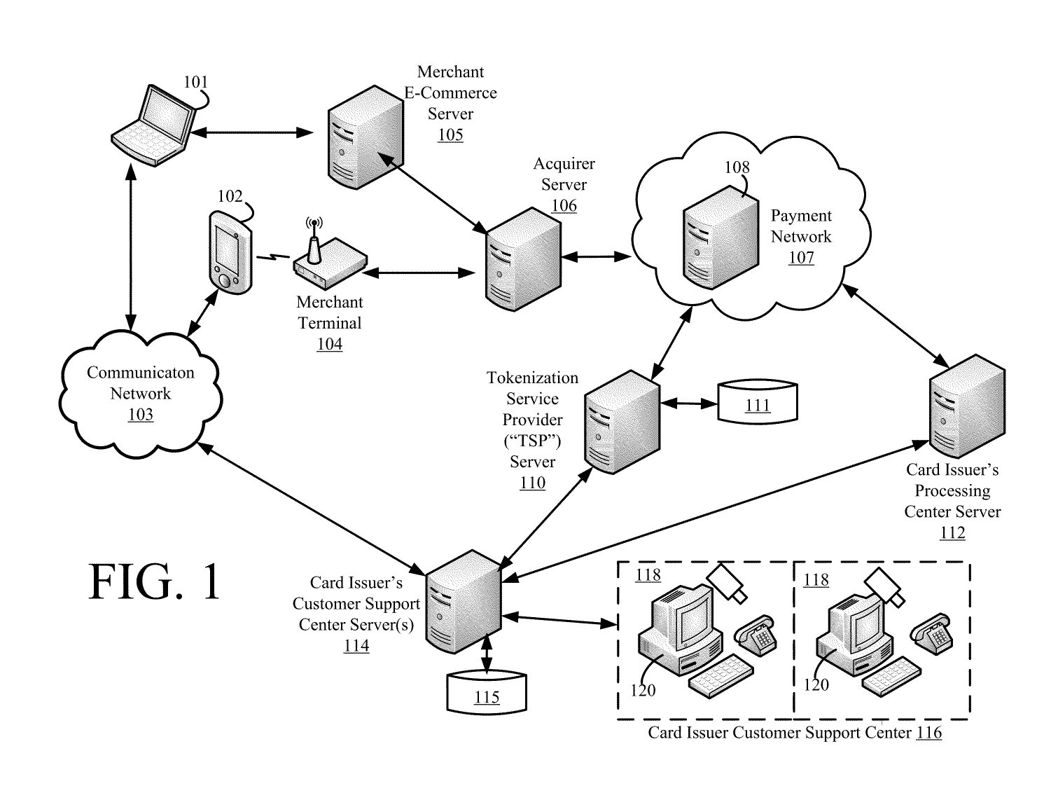

In an exemplary token generation and provisioning method, the process of obtaining the transaction token can involve communications between the customer's computing device and a server operated by the TSP. The process can begin by assigning an alphanumeric token requestor ID to the customer which allows the TSP to uniquely identify that particular customer. Once assigned a token requestor ID, the customer can request and be assigned a transaction token. For example, in FIG. 1, a customer computing device 101, 102 can communicate with a TSP server 110 to request the transaction token. In response, the TSP server 110 will verify that the request is authentic (e.g., pertains to a valid token requestor ID and pertains to a known PAN). Once the request has been authenticated, the TSP server 110 will generate or otherwise determine a transaction token that is to be used for the particular transaction and will communicate such transaction token to the customer's computing device 101, 102. The TSP server 110 will also maintain a record of the particular transaction token that has been issued with respect to the PAN and the particular token requestor ID. In some scenarios, these records can be stored in a relational database 111. Depending on the TSP, a transaction token can be used for multiple transactions or can be limited in terms of its use to a single transaction.

Once obtained by the customer's computing device, the transaction token can be used to complete card transactions. For example, the token can be provided to a merchant for purposes of executing a purchase transaction. The token requestor ID can also be provided to the merchant. In one scenario, a customer computing device 102 is a Portable Computing Device (“PCD”) such as a smart-phone. The smart phone uses a short range wireless communication method to communicate the transaction token to a merchant terminal 104. An exemplary short range wireless communication mode that can be used for this purpose can comprise a Near Field Communication (“NFC”) technology or Bluetooth®. However, other types of short range wireless communication devices are also possible. In another scenario, a customer uses a computing device 101, such as a laptop computer, to communicate a transaction token to a Merchant E-Commerce (“MEC”) server 105. Communications between the computing device 101 and the MEC server 105 can involve use of one or more publically accessible IP networks, including wireless networks and/or wired networks such as the Internet.

Alternatively, the customer can use his computing device 101, 102 to provide an actual PAN to a merchant input terminal and/or server 104, 105 using communication methods described above. Once the PAN is received, the merchant computing equipment will use a software application (e.g., a software application provided by a TSP) executing on a merchant computing device (e.g., MEC server 105) to request the required transaction token for the transaction from the TSP server 110. Transaction token generation and communication processes as described herein are known in the art and therefore will not be described in detail. However, it will be appreciated that a transaction token that is generated can advantageously be selected so as to have the format of a standard PAN (e.g., same number of digits). Accordingly, the transaction token can be communicated through the existing payment card processing infrastructure without difficulty.

Once obtained, a transaction token is processed in a manner similar to a conventional credit card transaction, but with certain additional steps added to facilitate use of the transaction token. For purposes of obtaining authorization, the transaction token is first communicated to processing facilities operated by an acquirer (e.g., a merchant bank or payment gateway) in the form of an authorization request. This communication can include with the token a requestor ID to help facilitate authorization. In FIG. 1, the acquirer processing facilities are represented by acquirer server 106. When the acquirer server receives the authorization request including the transaction token, it will submit the request to processing facilities associated with a Payment Network (“PN”) 107. In FIG. 1, these processing facilities are represented by a PN server 108. The PN server 108 will communicate the transaction token to the TSP server 110. The token requestor ID can be included in this communication to the TSP server 110. The TSP server 110 has a record of the PAN for which the transaction token was originally generated and can cross-reference the transaction token to determine the associated PAN. For security purposes, the TSP server 110 can also verify that the transaction token is a token which has been assigned to a customer having the particular token requestor ID. If the TSP server 110 determines that the token is valid, it will return the PAN value to the PN server 108, which will in turn submit the authorization request to certain processing facilities associated with the card issuer. In FIG. 1, these processing facilities are represented as a card issuer's Processing Center (“PC”) server 112.

The PC server 112 will determine if the transaction is authorized. Thereafter, the PC sever 112 will send its authorization response to the PN server 108. This authorization response can include the PAN. When the authorization response is received at the PN server 108, it can use the included PAN information to associate the authorization response with the transaction token that was originally generated for the transaction. The transaction token and the authorization response are then returned to the acquirer server 106 (without the PAN information). The acquirer server will respond by forwarding the authorization response to the merchant (e.g., MEC server 105 or merchant terminal 110) to indicate whether or not the transaction has been authorized. The transaction token can then be stored and used by the merchant as a reference or record of the transaction. For example, the transaction token could be used to assist with refunds and exchanges relating to the transaction.

The use of a transaction token obscures the PAN and other personally identifiable information associated with the user. A significant advantage of a tokenized transaction is that it eliminates the need for merchants and operators of mobile wallets to store sensitive credit, debit and/or reward card data on their networks, where such information may be vulnerable to hackers. In contrast to conventional credit card authorization methods, the tokenized payment process communicates to the merchant only the transaction token, which is of little use to data thieves. Moreover, for security against fraudulent transactions, and as a means of ensuring mechanisms to prevent the liabilities associated with identity theft of consumers, tokenized payment processors implementing tokenized payment services opt to store as little information about the consumer's card issuer as possible.

Although there are many advantages of tokenized credit/debit card transactions, they also present certain problems. There are some circumstances under which a consumer will need to obtain assistance from the card issuer in relation to the payment transaction. Likewise, it is often necessary for the merchant to call the merchant gateway vendor in connection with a particular transaction. The reasons for assistance can vary. For example, such reasons can involve balance inquiries, credit limit verifications, requests for credit limit increase, payments over credit limit authorization, and/or clearing of fraud detection alerts by the bank blocking the transaction. A consumer may also need to contact a card issuer to provide a general notification of using a card. Such notifications may be needed for a transaction that is either unusual or in a location outside of the consumer's normal spending locations. For example, such notifications may be appropriate when a consumer uses a credit card in a foreign country or while travelling abroad in general. Transaction related communications between the consumer and the card issuer can occur in advance of a purchase, during a purchase transaction with a merchant online or in person, or after a transaction has occurred.

The traditional methods of obtaining assistance by a consumer from their respective card issuer have been either online or by telephone. The online approach involves using the internet and receiving help from the web site of the card issuer using a plurality of modalities from web applications. For example, the online approach to obtaining assistance can involve using a web browser or other software in a customer computing device 101, 102 to facilitate an online live-media chat over a communication network 103, such as the Internet. The online live-media chat (e.g., a video chat) can be conducted using live media communication equipment 118 provided to a card issuer's agent at a card issuer's Customer Support Center (“CSC”) 116. The live media communication equipment 118 can include computing devices, video cameras, telephone equipment, video phones, and/or IP telephones. A computer workstation 120 can be provided to support such live media communication session and/or to facilitate certain customer support interactions by displaying account information on a display device.

Communications with the card issuer's CSC can and often are facilitated through use of one or more CSC server(s) 114 of the card issuer. The CSC server 114 can serve one or more HTML web pages that facilitate or support live media communication sessions with card issuer's CSC agents. The CSC server 114 can also execute one or more software applications for implementing Interactive Voice Response (“IVR”) systems (or Visual Interactive Response (“VIR”) systems) that allow a computer to interact with humans through the use of voice and DTMF tones input via keypad, before a communication session is established with a card issuer customer support center agent.

Still, conventional telephone methods for obtaining assistance from a credit card issuer require use of a telephone number provided by the card issuer. As a practical matter, these transactions are such that if a consumer wishes to obtain phone assistance from the card issuer in relation to the payment transaction, the consumer needs to have their card present (since it lists PAN and card issuer contact information on its face) and/or must know the phone number/web site address of the support department of the card issuer. The internet and telephone modalities for obtaining assistance from the card issuer are commonly referred to as consumer support channels.

With the advent of tokenization as a means of securing personal consumer information during the transaction, the merchant is limited to receiving assistance from the TSP. The merchant will lack information concerning the actual PAN and/or card issuer and therefore will have difficulty trying to resolve any payment issues. However, the TSP normally does not have or is not allowed to disclose the personal information of the consumer to the merchant. Accordingly, it is largely left to the consumer to resolve any transaction issues that arise.

But with the advent of tokenized payment systems, it can involve multiple steps for consumers to resolve transaction issues. The consumer has to independently identify the appropriate support mechanism/contact information for their card issuer. Once the appropriate support mechanism is selected, such consumer will need to (1) leave the payment application (e.g., a tokenized payment and/or mobile wallet software application) that is in use on their portable computing device for purposes of executing the current card transaction. They will then have to (2) visit the card issuer's web site to obtain the card issuers contact information, or physically look at their credit card or some image of their card to obtain contact information, or access a software application (e.g., a contact database) that stores the relevant telephone support number. Finally, (3) they will need to access a communication application (e.g., a telephone) or browser application on their device to facilitate conducting the actual communication session with the card issuer customer support center representative. These actions are often times consuming and inconvenient for the consumer.

At a certain point in time when utilizing a card issuer support mechanism, the consumer will actually gain contact with an agent of his card issuer. At that point, the card issuer agent must ask a series of questions to establish the consumer's identity, load information regarding recent transactions of the consumer, and access the database containing the consumers personal account information. The agent must also ask the consumer what assistance they are requesting or what transaction they are calling in reference to. These mechanisms can also be viewed by consumers as time consuming and complicated. As such these conventional methods of seeking assistance during card transactions create a level of dissatisfaction. The dissatisfaction can arise with the consumer when they are trying to make a purchase, and/or with the merchant who is now spending more time with the consumer due to some problem

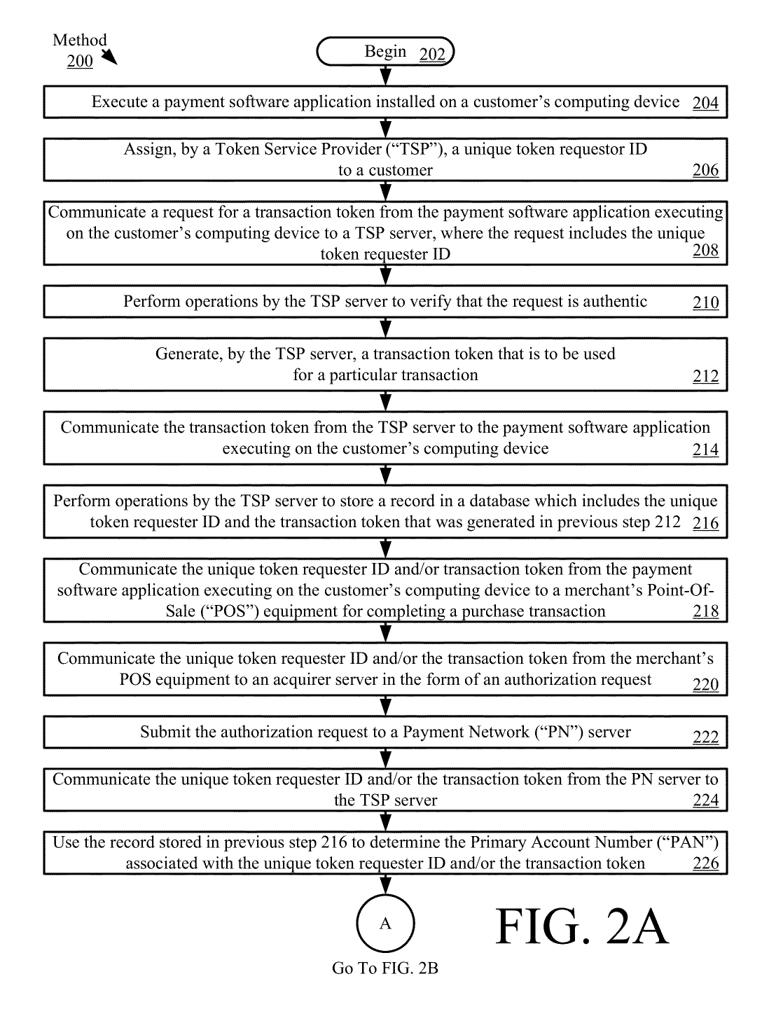

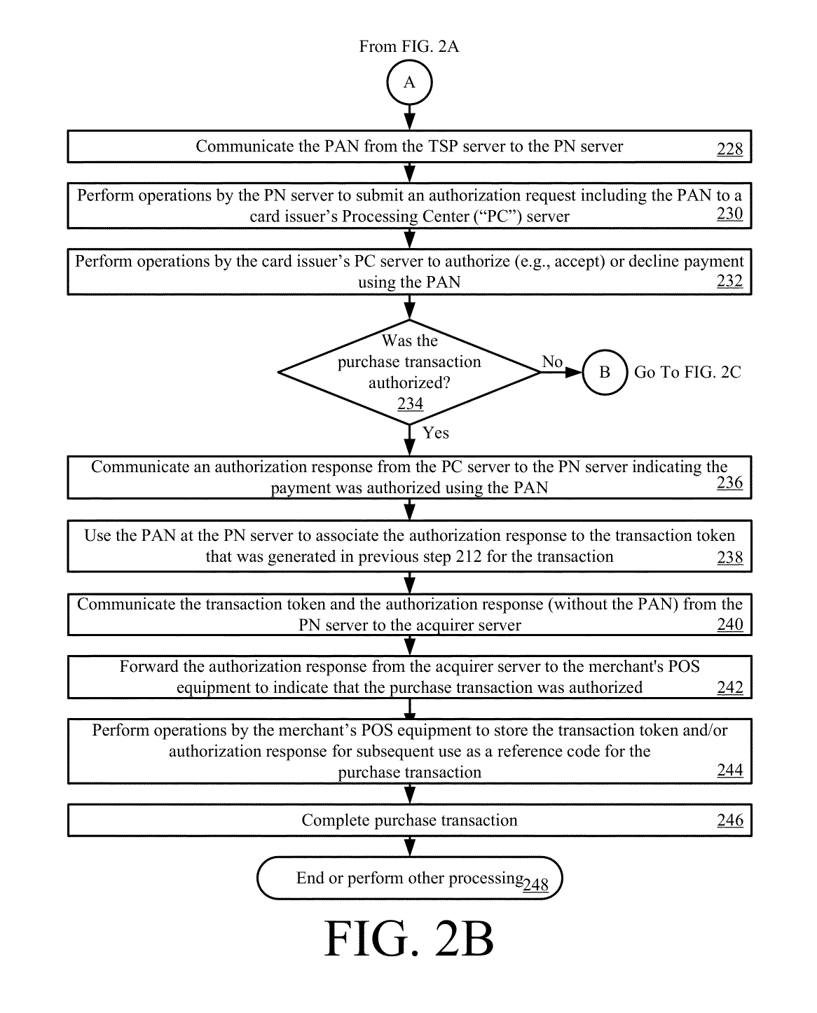

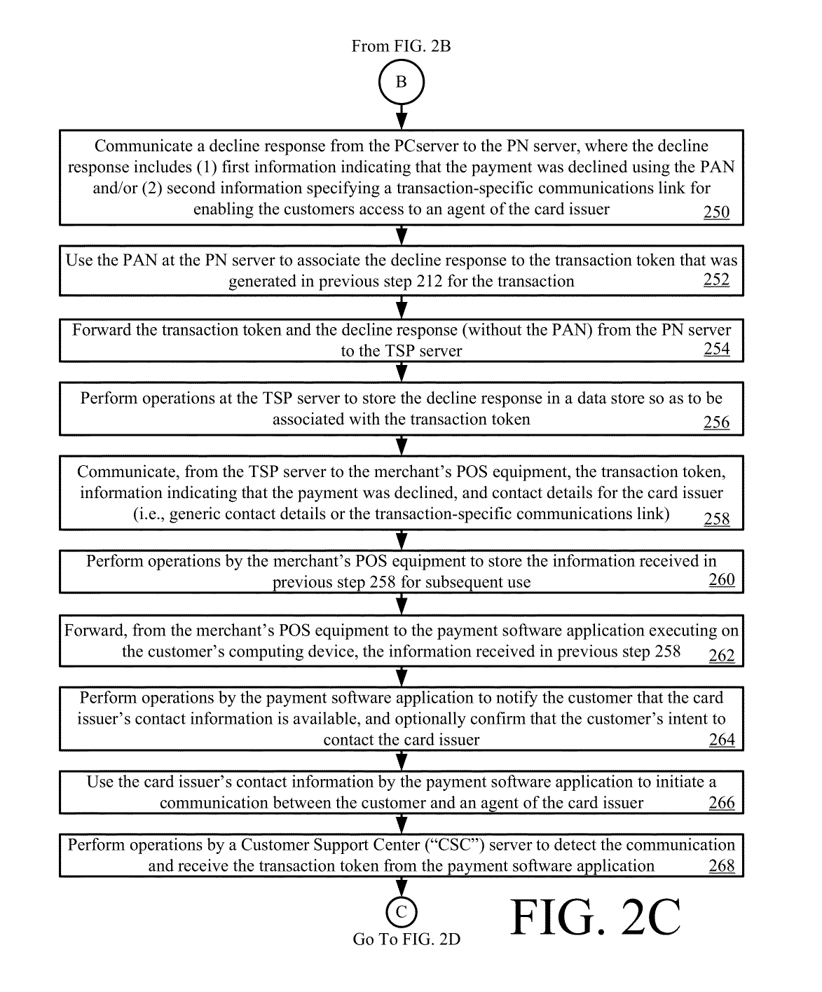

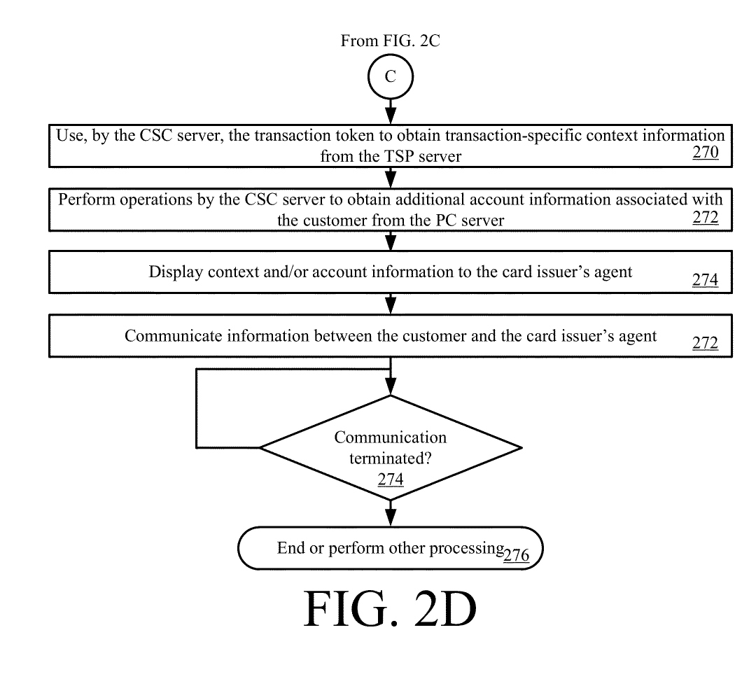

FIGS. 2A-2D collectively provide a flowchart that is useful for understanding a method that allows tokenized payment processors to use tokenization information in a novel way. This method and system facilitates card issuer support to customers without requiring a consumer to search for or use alternative mechanisms of contacting their card issuer as described above. In other words, the assistance to the user can be provided directly within the tokenized payment processor application, while still ensuring the personal information of the consumer is not disclosed. According to one aspect of the invention, an automated mechanism is provided to facilitate initializing a voice/video call to the card issuer from a consumer computing device being used to facilitate the tokenized card transaction. The mechanism further facilitates notification to the card issuer (in an automated fashion) of contextual information relating to the transaction in which assistance is required. Contextual information can include, but is not limited to, information that is useful for verifying the consumer identity, full details of the transaction in question, and any relevant information pertaining to the transaction. As such, the card issuer does not have to request the information from the consumer again when actually providing assistance. Further still, the consumer is relieved from the necessity of needing to know the card issuer's phone number to request credit card transaction support, and does not need to leave the tokenized payment processing application while requesting support.

As shown in FIG. 2A, the method 200 begins with step 202 and continues with step 204 where a payment software application is executed on a customer's computing device (e.g., computing device 101 or 102 of FIG. 1). The payment software application is capable of performing tokenized card transactions similar to those described above with respect to FIG. 1. Next in step 206, a TSP assigns a unique token requester ID to the customer. Notably, step 206 may performed prior to step 204, rather than subsequent to step 204 as shown in FIG. 2A.

When the customer desires to purchase a retail item, step 208 is performed where the payment software application generates a request for a transaction token. The request includes the unique token requester ID. The request is communicated from the payment software application to a TSP server (e.g., TSP server 110 of FIG. 1). At the TSP server, operations are performed in step 210 to verify that the request is authentic. Upon verification that the request is authentic, the TSP server generates a transaction token that is to be used for a particular transaction, as shown by step 212. In a next step 214, the transaction token is communicated from the TSP server to the payment software application executing on the customer's computing device. The TSP server also stores a record in a database (e.g., data store 111 of FIG. 1) which includes the unique token requester ID and the transaction token, as shown by step 216

Subsequently in step 218, the unique token requester ID and/or transaction token is/are communicated from the payment software application to a merchant's Point-of-Sale (“POS”) equipment (e.g., merchant terminal 104 or MEC server 105 of FIG. 1). In turn, the POS equipment communicates the unique token requester ID and/or transaction token to an acquirer server (e.g., acquirer server 106 of FIG. 1) in the form of an authorization request, as shown by step 220. In a next step 222, the acquirer server submits the authorization request to a PN server (e.g., PN server 108 of FIG. 1). The PN server communicates the unique token requester ID and/or the transaction token to the TSP server, as shown by step 224.

At the TSP server, step 226 of FIG. 2A and step 228 of FIG. 228 are performed. Step 226 involves using the record stored in previous step 216 to determine the PAN associated with the unique token requester ID and/or the transaction token. Step 228 involves communicating the PAN from the TSP server to the PN server.

At the PN server, operations are performed to submit an authorization request including the PAN to a card issuer's PC server (e.g., PC server 112 of FIG. 1), as shown by step 230. In a next step 232, the PC server performs operations to authorize or decline payment using the PAN. If payment was authorized [234:YES], then method 200 continues with steps 236-246. These steps involve: communicating an authorization response from the PC server to the PN server indicating that the payment was authorized using the PAN; using the PAN at the PN server to associate the authorization response to the transaction token that was generated in previous step 212 for the transaction; communicating the transaction token and the authorization response (without the PAN) from the PN server to the acquirer server; forwarding the authorization response from the acquirer server to the merchant's POS equipment to indicate that the purchase transaction was authorized; performing operations by the merchant's POS equipment to store the transaction token and/or authorization response for subsequent use as a reference code for the purchase transaction; and complete the purchase transaction. Upon completing step 246, step 248 is performed where method 200 ends or other processing is performed.

In contrast, if the payment was declined [234:NO], then method 200 continues with steps 250-268 of FIG. 2C. As shown in FIG. 2C, step 250 involves communicating the decline response from the PC server to the PN server. The decline response includes (1) first information indicating that the payment was declined using the PAN and/or (2) second information specifying a transaction-specific communications link for enabling the customer's access to an agent of the card issuer. In step 252, the PAN is used by the PN server to associate the decline response to the transaction token that was generated in previous step 212 for the transaction. Thereafter in step 254, the transaction token and the decline response (without the PAN) is forwarded from the PN server to the TSP server. The TSP server then performs operations in step 256 to store the decline response in a data store (e.g., data store 111 of FIG. 1) so as to be associated with the transaction token.

The TSP server also performs actions in step 258 to communicate the transaction token and other information to the merchant's POS equipment. The other information can include information indicating that the payment was declined and/or contact details for the card issuer (i.e., generic contact details or the transactions-specific communications link). The POS equipment then stores the received information for subsequent use, as shown by step 260. The POS equipment also forwards in step 262 the received information to the payment software application running in the customer's computing device.

Upon receipt of said information, the payment software application performs operations in step 264 to notify the customer that the card issuer's contact information is available. The payment software application can also optionally request confirmation that the customer wishes to initiate a live media communication session with a customer support center (e.g., CSC 116 of FIG. 1). Alternatively, the payment software application can skip the confirmation step and can instead automatically proceed to use the contact information to initiate the communication session with the credit card issuer CSC. In either scenario, a live media communication session is initiated at 266 with the card issuer's CSC. The live media communication session can include a voice communication session and/or a video communication session.

At step 268, the card issuer's CSC server (e.g., CSC server 114 of FIG. 1) detects that the payment software application (executing at the customer's computing device) has initiated a request to establish a live media communication session with the card issuer's CSC. In response to this request, the CSC server can perform actions to initiate such a communication session. These actions can involve serving one or more web pages to the customer's computing device, and/or participating in a signaling session to facilitate call setup. Actions associated with setup of a live media communication session are known in the art and therefore will not be described here in detail. Further, although a single CSC server is mentioned for performing the call setup, signaling and subsequent media communications operations associated with a live media communication session, it should be appreciated that these actions can actually be performed by two or more servers at the card issuer CSC. For example, dedicated servers can be respectively provided for serving web pages, signaling and media formatting operations as is known.

As part of the foregoing call setup actions, the CSC server will request and obtain the transaction token from the customer's computing device, as shown by step 268. Alternatively, the transaction token can be communicated to the CSC server as part of the initial request to establish a communication session. Accordingly, the transaction token can be obtained by the CSC server before, during or after call setup. The customer's computing device can also provide the CSC server with a token requestor ID.

Upon completing step 268, method 200 continues with step 270 of FIG. 2D. As shown in FIG. 2D, the CSC server will in step 270 communicate a request for transaction-specific context information pertaining to the particular transaction token. The request can also optionally include a token requestor ID and/or transaction token. This request can be communicated to the TSP server by means of a public IP network, such as the Internet and/or a private IP network (e.g., the payment network 107 of FIG. 1). In response to such request, the TSP server will associate the transaction token and/or token requestor ID with a PAN stored in a database (e.g., data base 111 of FIG. 1). If the TSP possesses other personal information concerning the card user, such information can also be accessed. The context information retrieved by the TSP server can then be communicated from the TSP server to the CSC server, as shown by step 272.

In other scenarios, the TSP server concurrently provides the same transaction token to the customer's computing device and to the card issuer's CSC server. The TSP server can optionally also provide the CSC server with a telephone number and/or MAC address associated with the customer's computing device. This information received from the TSP server can be stored in a database (e.g., database 115 of FIG. 1). Thereafter, when a voice or video call is initiated from the customer's computing device, the phone number and/or MAC address of the device is paired with the transaction token by consulting the information contained in the database. The CSC server will recognize the telephone number and/or MAC address of the customer's computing device which is initiating a communication session. The CSC server can then match the telephone number to the stored transaction token associated with the telephone number and/or MAC address to facilitate retrieval of the context information stored by the TSP server. Alternatively, the customer's computing device can provide its transaction token to the CSC server, and the server can authenticate the customer's computing device by determining that the transaction token matches the incoming telephone number stored in its database.

After the CSC server associates a transaction token with a particular incoming communication (i.e., a communication from a customer's computing device), the CSC server can use that information to initiate and/or prevent certain actions. For example, the CSC server can prevent certain automated actions associated with retrieval of context information from the customer's computing device. Such context information is no longer needed from the customer's computing device since it has already been made available to CSC server from the TSP server.

Referring again to FIG. 2D, the CSC server can use the context information in step 272 to obtain more detailed account information concerning the PAN. For example, such information can be requested and obtained from the card issuer's PC server. Such information can include customer name, address, telephone number, security information, recent account transaction data, more detailed customer information, and/or card authorization data that may be useful for assisting a customer. After appropriate context information has been obtained, all or part of the information can be made available for display at step 274 using a display device associated with an agent's computer workstation (e.g., workstation 120 of FIG. 1). The information thus displayed is useful to card issuer customer service agents as an aid in providing customer service. Notably, the context information can be obtained and displayed without any need for the customer service representative to obtain account number (e.g., the PAN) or other personal information from a customer (i.e., a user of a customer's computing device). In step 274, the system can wait for the live media communication to be completed, after which the process is terminated (or returns to transaction processing) in step 276.

It will be appreciated that in addition to expediting support call processing, the process described herein also obviates the need for customer authorization by the customer support center agents. In tokenized transactions, a customer or user must authenticate themselves to their computing device (e.g. smartphone) before the token transaction software on the device will proceed with the tokenized card transaction. This authentication can occur by means of an alphanumeric password or by providing certain biometric data, such as a fingerprint scan. Accordingly, when a transaction token is received by a card issuer's CSC at step 268 and used to access context information, there is no further need for a card issuer's CSC to authenticate the user. Authentication is already complete and customer support for the transaction can proceed without delay.

No further information needs to be gathered by the card issuer. The card issuer's CSC server will already have context information relating to the transaction. Such context information can include the merchant, the location, the consumer identity, the card account information (e.g., the PAN), the goods or services being purchased, along with any other relevant information related to the transaction including but not limited to information regarding the result of the attempted transaction, whether it was declined or approved, or any other of a plurality of information that may aid in the employee of card issuer to assist the consumer.

Although the invention has been described herein as using the same transaction token for authorization and customer support purposes, it should be understood that the invention is not limited in this regard. Instead, a transaction token can be used in a conventional manner for authorization purposes and a different token (context token) could be used to facilitate customer support actions as described herein. For example, the context token could be generated by the TSP server for provision along with the card issuer contact details. The context token could then be provided by the TSP server to the customer computing device using method similar to those already described with respect to the transaction token. Optionally, the context token could be concurrently provided by the TSP server to both the customer's computing device and to the card issuer's CSC server. Thereafter, when the customer's computing device initiates a telephone or video conference call to the card issuer's CSC server, the context token would be used instead of the transaction token to obtain context information from the TSP server. In other respects, the process would be similar to that described in FIGS. 2A-2D with respect to the use of the transaction token for this purpose.

The present invention can be realized in one computer system. Alternatively, the present invention can be realized in several interconnected computer systems. The phrase “computer system” shall be understood to include any collection of computing devices that individually or jointly execute a set (or multiple sets) of instructions to perform any one or more of the methodologies discussed herein. Any kind of computer system or other apparatus adapted for carrying out the methods described herein is suited. A typical combination of hardware and software can be a general-purpose computer system. The general-purpose computer system can have a computer program that can control the computer system such that it carries out the methods described herein.

A computer system for implementing the invention can comprise various types of computing systems and devices, including a server computer, a client user computer, a Personal Computer (“PC”), a tablet computer, a laptop computer, a desktop computer, a smartphone, or any other device capable of executing a set of instructions (sequential or otherwise) that specifies actions to be taken by that device.

The present invention can take the form of a computer program product on a computer-usable storage medium (for example, a hard disk or a CD-ROM). The computer-usable storage medium can have computer-usable program code embodied in the medium. The term computer program product, as used herein, refers to a device comprised of all the features enabling the implementation of the methods described herein. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

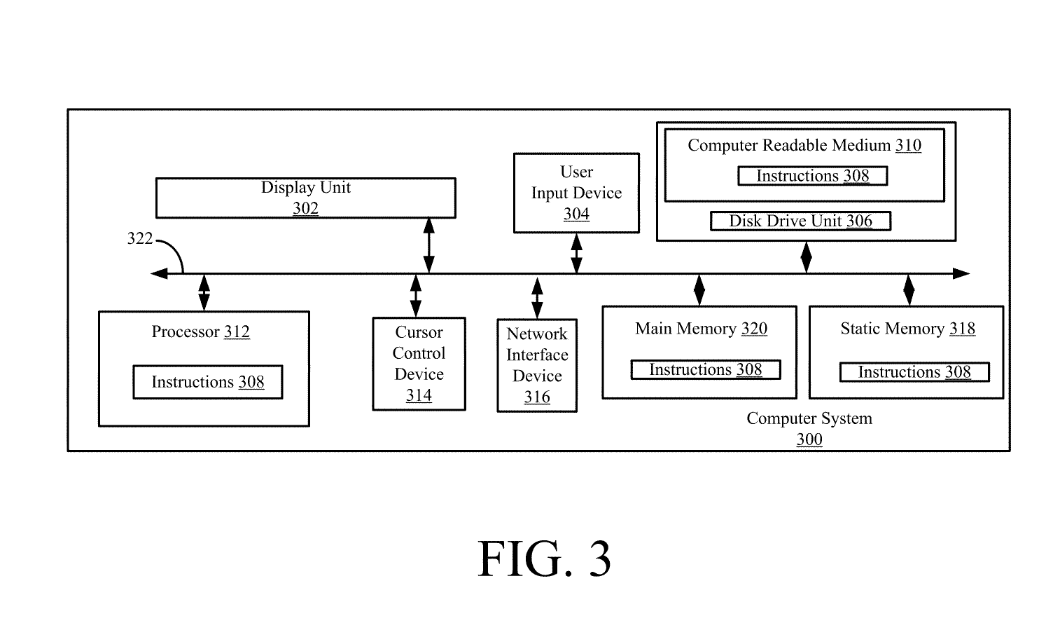

Referring now to FIG. 3, an exemplary computer system 300 includes a processor 312 (such as a Central Processing Unit (“CPU”)), a disk drive unit 306, a main memory 320 and a static memory 318, which communicate with each other via a bus 322. The computer system 300 can further include a display unit 302, such as a video display (e.g., a Liquid Crystal Display (“LCD”)), a flat panel, a solid state display, or a Cathode Ray Tube (“CRT”)). The computer system 300 can include a user input device 304 (e.g., a keyboard), a cursor control device 314 (e.g., a mouse) and a network interface device 316.

The disk drive unit 306 includes a computer-readable storage medium 310 on which is stored one or more sets of instructions 308 (e.g., software code) configured to implement one or more of the methodologies, procedures, or functions described herein. The instructions 308 can also reside, completely or at least partially, within the main memory 320, the static memory 318, and/or within the processor 312 during execution thereof by the computer system. The main memory 320 and the processor 312 also can constitute machine-readable media.

Those skilled in the art will appreciate that the computer system architecture illustrated in FIG. 3 is one possible example of a computer system. However, the invention is not limited in this regard and any other suitable computer system architecture can also be used without limitation. Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments may implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present invention, the methods described herein are stored as software programs in a computer-readable storage medium and are configured for running on a computer processor. Furthermore, software implementations can include, but are not limited to, distributed processing, component/object distributed processing, parallel processing, virtual machine processing, which can also be constructed to implement the methods described herein. In the various embodiments of the present invention a network interface device 316 connected to a network environment communicates over the network using the instructions 308.

While the computer-readable storage medium 310 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical mediums such as a disk or tape. Accordingly, the disclosure is considered to include any one or more of a computer-readable medium as listed herein and to include recognized equivalents and successor media, in which the software implementations herein are stored.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method for performing a purchase transaction, comprising:
receiving, by a first computing device operated by a first person, a first transaction token generated by a Tokenization Service Provider (“TSP”) server operated by a TSP;
using the first transaction token to complete a first purchase transaction; and
when payment is declined during the first purchase transaction,
automatically providing contact details for a card issuer to the first computing device so that a communication session between the first person and a card issuer can be initialized without requiring the first person to search for the contact details, and
automatically using the first transaction token to retrieve and provide the card issuer with at least one of transaction-specific context information pertaining to the first transaction and account information associated with the first person.

2. The method according to claim 1, further comprising:
assigning a first token requester identifier to the first person which allows the TSP to unique identify the first person,
receiving a request for the first transaction token from the first computing device, where the request comprises the first token requester identifier,
verifying that the request is authentic,
generating the first transaction token upon verification that the request is authentic, and
communicating the first transaction token to the first computing device so that the first transaction token can be used to complete the first transaction.

3. The method according to claim 2, further comprising receiving by a second computing device operated by a merchant at least one of the first token requester identifier and the first transaction token which was communicated from the first computing device.

4. The method according to claim 3, further comprising:
communicating at least one of the first token requester identifier and the first transaction token from the second computing device to an acquirer server in the form of an authorization request;
performing operations by the acquirer server to submit the authorization request to a Payment Network (“PN”) server;
communicating at least one of the first token requester identifier and the first transaction token from the PN sever to the TSP sever;
performing operations by the TSP server to determine a Primary Account Number (“PAN”) associated with at least one of the first token requester identifier and the first transaction token;
communicating the PAN from the TSP server to the PN server;
performing operations by the PN server to submit an authorization request including the PAN to a Processing Center (“PC”) server; and
perform operations by the PC server to accept or decline payment using the PAN.

5. The method according to claim 4, further comprising performing the following operations if the payment is accepted:
communicating an authorization response from the PC server to the PN server indicating that the payment was authorized using the PAN;
using the PAN at the PN server to associate the authorization response to the first transaction token;
communicating the first transaction token and the authorization response without the PAN from the PN server to the acquirer server;
forwarding the authorization response from the acquirer server to a second computing device operated by a merchant to indicate that the purchase transaction was authorized; and
using by the second computing device the first transaction token to complete the purchase transaction.

6. The method according to claim 4, further comprising performing the following operations if the payment is declined:
communicating a decline response from the PC server to the PN server, where the decline response comprises at least one of (1) first information indicating that payment was declined using the PAN and (2) second information specifying a transaction-specific communications link for enabling the first computing device's access to an agent;
using by the PN server the PAN to associate the decline response to the first transaction token;
forwarding the decline response and the transaction token from the PN server to the TSP server; and
communicating at least one of the transaction token, information indicating that payment has been declined, and information specifying contact details for a card issuer from the TSP server to a second computing device operated by a merchant.

7. The method according to claim 1, wherein the contact details are used by the first computing device to initiate the communication session with the card issuer.

8. The method according to claim 7, wherein a card issuer server obtains the first transaction token from the first computing device before, during or after initiation of the communication session.

9. The method according to claim 8, wherein the card issuer server uses the first transaction token to obtain at least one of the transaction-specific context information pertaining to the first transaction and the account information associated with the first person.

10. A system, comprising:
a first computing device operated by a first person that is configured to
receive a first transaction token generated by a Tokenization Service Provider (“TSP”) server operated by a TSP, and
use the first transaction token to complete a first purchase transaction;
wherein contact details for a card issuer are automatically provided to the first computing device so that a communication session between the first person and a card issuer can be initialized without requiring the first person to search for the contact details, when payment is declined during the first purchase transaction.

11. The system according to claim 10, wherein the TSP server is configured to
assign a first token requester identifier to the first person which allows the TSP to uniquely identify the first person,
receive a request for the first transaction token from the first computing device, where the request comprises the first token requester identifier,
verify that the request is authentic,
generate the first transaction token upon verification that the request is authentic, and
communicate the first transaction token to the first computing device so that the first transaction token can be used to complete the first transaction.

12. The system according to claim 11, further comprising a second computing device operated by a merchant that is configured to receive at least one of the first token requester identifier and the first transaction token which was communicated from the first computing device.

13. The system according to claim 12, wherein:
at least one of the first token requester identifier and the first transaction token is communicated from the second computing device to an acquirer server in the form of an authorization request;
the acquirer server performs operations to submit the authorization request to a Payment Network (“PN”) server;
at least one of the first token requester identifier and the first transaction token is communicated from the PN sever to the TSP sever;
the TSP server performs operations to determine a Primary Account Number (“PAN”) associated with at least one of the first token requester identifier and the first transaction token;
the PAN is communicated from the TSP server to the PN server;
the PN server performs operations to submit an authorization request including the PAN to a Processing Center (“PC”) server; and
the PC server performs operations to accept or decline payment using the PAN.

14. The system according to claim 13, wherein the following occurs if the payment is accepted:
an authorization response is communicated from the PC server to the PN server indicating that the payment was authorized using the PAN;
the PAN is used at the PN server to associate the authorization response to the first transaction token;
the first transaction token and the authorization response without the PAN is communicated from the PN server to the acquirer server;
the authorization response is forwarded from the acquirer server to a second computing device operated by a merchant to indicate that the purchase transaction was authorized;
the second computing device uses the first transaction token to complete the purchase transaction.

15. The system according to claim 13, wherein the following actions are performed if the payment is declined:
a decline response is communicated from the PC server to the PN server, where the decline response comprises at least one of (1) first information indicating that payment was declined using the PAN and (2) second information specifying a transaction-specific communications link for enabling the first computing device's access to an agent;
the PN server uses the PAN to associate the decline response to the first transaction token;
the decline response and the transaction token is forwarded from the PN server to the TSP server; and
at least one of the transaction token, information indicating that payment has been declined, and information specifying contact details for a card issuer is communicated from the TSP server to a second computing device operated by a merchant.

16. The system according to claim 10, wherein the contact details are used by the first computing device to initiate the communication session with the card issuer.

17. The system according to claim 10, wherein a card issuer server obtains the first transaction token from the first computing device before, during or after initiation of the communication session.

18. The system according to claim 17, wherein the card issuer server uses the first transaction token to obtain at least one of the transaction-specific context information pertaining to the first transaction and the account information associated with the first person.
